(19) United States
(12) Patent Application Publication
(10) Pub. No.: US 2025/0376884 A1
(43) Pub. Date: Dec. 11, 2025

(54) Stop for a Vehicle Hood or Tailgate

(71) Applicant: Illinois Tool Works Inc., Glenview, IL (US)

(72) Inventors: Andrea Giovanni Coccoz, Ivrea (IT); Andrea Barberis, Turin (IT); Hervé Antoine, Obersoultzbach (FR); Fulvio Pacifico Yon, Donnas (IT)

(21) Appl. No.: 19/220,358

(22) Filed: May 28, 2025

(30) Foreign Application Priority Data
Jun. 5, 2024 (FR) 2405935

(51) Int. Cl. E05F 5/02

(52) U.S. Cl. CPC E05F 5/022

(57) ABSTRACT

The disclosure relates to a stop (1) used on a vehicle's hood or tailgate. The stop includes a base (2) with a connector (3) that attaches it to the hood or tailgate, a gasket (4) that seals against the hood or tailgate, and a stopper (5) that contacts the vehicle body to absorb the force when closing. The base (2) is made of one material, while the stopper (5) and gasket (4) are made of a second material that is overmolded onto the base. The base has one or more holes (20) that allow the second material to connect the stopper and gasket through it.

### RELATED APPLICATION

The present application claims the benefit of French Patent Application No. FR 2405935, filed June 5, 2024, titled “Stop for a Vehicle Hood or Tailgate,” the contents of which are hereby incorporated by reference.

### BACKGROUND

Stops are commonplace and normally comprise a stopper mounted on the vehicle hood or tailgate to engage the vehicle body in order to dampen a closing force of the hood or tailgate.

The present disclosure generally relates to a stop for the hood or tailgate of a vehicle.

The present disclosure relates generally to a stop for the hood or tailgate of a vehicle, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a front view of a stop according to the disclosure.

FIG. 2 illustrates a side view of the stop in FIG. 1.

FIG. 3 illustrates a cross-sectional view of the stop in FIGS. 1 to 3, showing the cage legs embedded in the second material.

FIG. 4 illustrates a cross-sectional view similar to the one in FIG. 3, but showing one of the through-holes in the base that connects the stopper to the gasket and showing the interaction with a panel of a hood or tailgate.

FIG. 5 illustrates a perspective view of the base without the stopper or the gasket.

FIG. 6 illustrates a cross-sectional view of the base in FIG. 5, showing two of its through-holes.

FIG. 7 illustrates a partial perspective view of the base in FIGS. 5 and 6, showing two of the through-holes in the base.

FIG. 8 illustrates a top view of the base in FIGS. 5 to 7, showing the ridges on the central core.

### DETAILED DESCRIPTION OF THE DISCLOSURE

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure aims to provide a more robust stop and/or one that has one or more advantages over known stops.

The disclosure relates to a stop, for example for the hood or tailgate of a vehicle, the stop comprising a base with a connector for mounting the stop on the hood or tailgate of the vehicle and a stopper for engaging the bodywork of the vehicle in order to dampen a closing force of the hood or tailgate, the base being made of a first material and the stopper being made of a second material overmolded onto the first material and which is softer or more flexible than the first material.

The stopper is thus held more securely to the base and consequently to the hood or tailgate.

The stop can comprise a gasket, for example to ensure the seal against the vehicle hood or tailgate. The gasket can be made of the second material and/or can be overmolded onto the first material. The base can have one or more holes, for example, through which the second material can connect the stopper and the gasket.

The disclosure also relates to a stop for the hood or tailgate of a vehicle, the stop comprising a base with a connector for mounting the stop on the hood or tailgate of the vehicle, a gasket to ensure the seal against the hood or tailgate of the vehicle and a stopper for engaging the bodywork of the vehicle in order to dampen a closing force of the hood or tailgate, the base being made of a first material and the stopper and gasket both being made of a second material overmolded onto the first material, the base having one or more holes through which the second material connects the stopper and the gasket.

The second material can be softer or more flexible than the first material.

The base can comprise a central core. The base can comprise a sleeve, which can envelop the central core. A portion of the second material can be held between the sleeve and the central core.

More specifically, the base can comprise a central core and a sleeve enveloping the central core, with a portion of the second material held between the sleeve and the central core.

The central core can be connected to the sleeve, for example by an annular wall. The hole or holes can extend through the annular wall.

More specifically, the central core can be connected to the sleeve by an annular wall through which the hole or holes extend.

The connector can be at a first end of the stop. The stopper can be at a second end of the stop. The gasket can be located between the annular wall and the connector.

More specifically, the connector can be at a first end of the stop with the stopper at a second end of the stop and the gasket located between the annular wall and the connector.

There can be a space between the gasket and the connector so that a panel of the hood or tailgate can be held between the connector and the gasket.

The base can comprise one or more ridges. The ridge or ridges can be embedded in the second material, for example to keep the stopper from rotating relative to the base.

The ridge or ridges can be located between the central core and the sleeve.

More specifically, the base can comprise one or more ridges between the central core and the sleeve that are embedded in the second material to keep the stopper from rotating relative to the base.

The ridge or ridges can protrude radially from the central core towards the sleeve.

A portion of the second material can extend along the outside of the sleeve.

The sleeve can comprise one or more channels, for example along its outer surface. The second material can extend into the or each channel, for example to connect the stopper and the gasket.

More specifically, the sleeve can comprise a channel along its outer surface and the second material extends into the channel to connect the stopper and the gasket.

The sleeve can comprise at least one ridge, for example on its outer surface. The sleeve can comprise a pair of ridges on opposite sides of the sleeve. The ridges can provide means for engaging a tool, for example to enable the tool to apply torque to install the stop on a hood or tailgate.

The channel can be provided inside one of the ridges.

More specifically, the channel can be provided inside one of two ridges on opposite sides of the sleeve.

The channel or channels can comprise a pair of channels on opposite sides of the sleeve. For example, one of each channel can be provided inside one of the ridges.

The base can comprise a cage. The cage can be embedded in the second material, for example to reinforce the connection between the base and the stopper.

More specifically, the base can comprise a cage that is embedded in the second material to reinforce the connection between the base and the stopper.

The cage can comprise a support end, for example, against which the stopper is compressed when in use. The support end can be connected to the rest of the base by a plurality of legs. The legs can be embedded in the second material.

More specifically, the cage can comprise a support end against which the stopper is compressed when in use, the support end being connected to the rest of the base by a plurality of legs embedded in the second material.

The support end can comprise a substantially flat disc.

The connector can comprise a bayonet connector designed to fit into a hole in a hood or tailgate panel.

The gasket can comprise a skirt. The gasket or skirt can be conical or tapered. The gasket or skirt can open out towards the connector.

More specifically, the gasket can comprise a tapered skirt that opens out towards the connector.

The connector can comprise one or more reinforcement arms, for example a pair of reinforcement arms. The reinforcement arm or arms can extend from the central core, for example to the inside of the skirt.

The bayonet connector can comprise one or more, for example two, connecting elements. At least one of the connecting elements can comprise a ramp. The ramp or ramps can force the panel against the reinforcement arm or arms. The reinforcement arm or arms can bend, for example to enable the panel to sealingly engage with the gasket or skirt, for example when the connector is rotated relative to the panel.

The disclosure also relates to a hood or tailgate assembly with the aforementioned stop mounted thereon.

The disclosure also relates to a vehicle with the aforementioned stop mounted on its hood or tailgate.

In order to avoid any doubt, all the features described herein also apply to any aspect of the disclosure.

In order to avoid any ambiguity, the terms “can”, “and/or”, “for example”, and any other similar term used in the present document are to be interpreted as not limiting, such that any feature thus described is not necessarily required to be present.

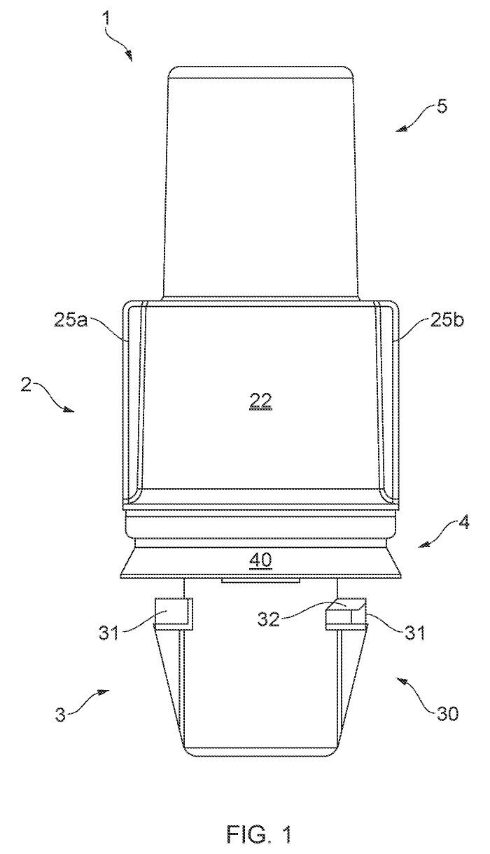

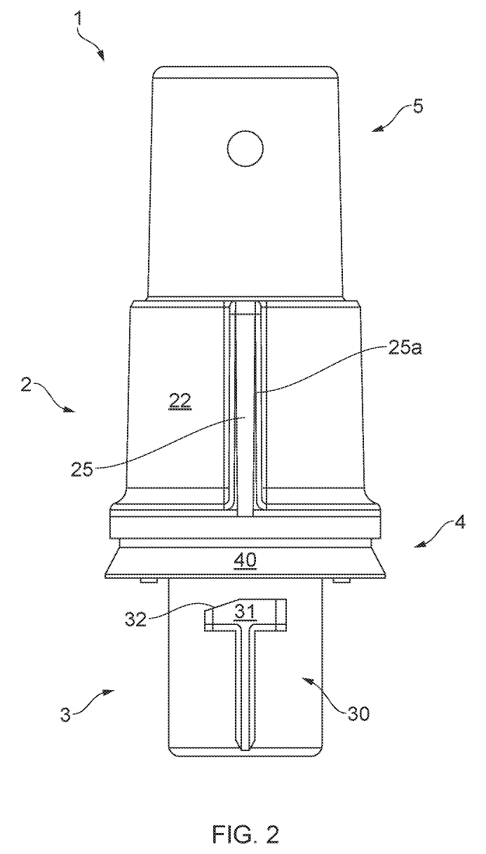

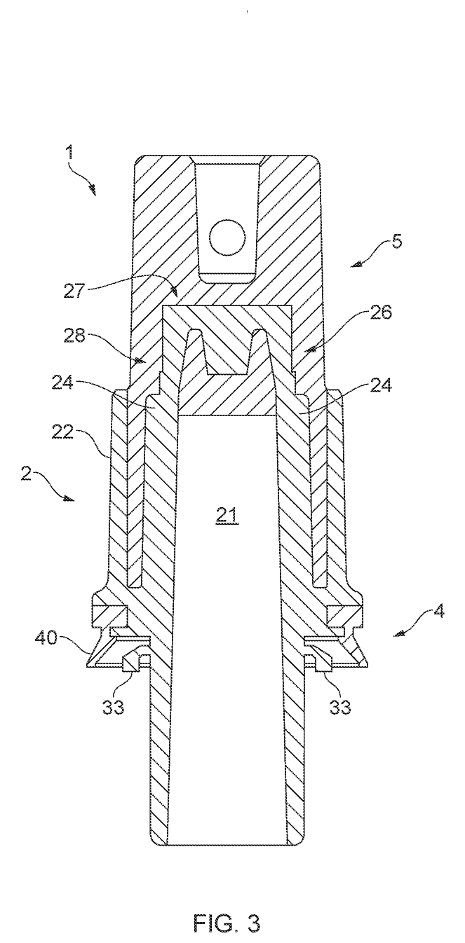

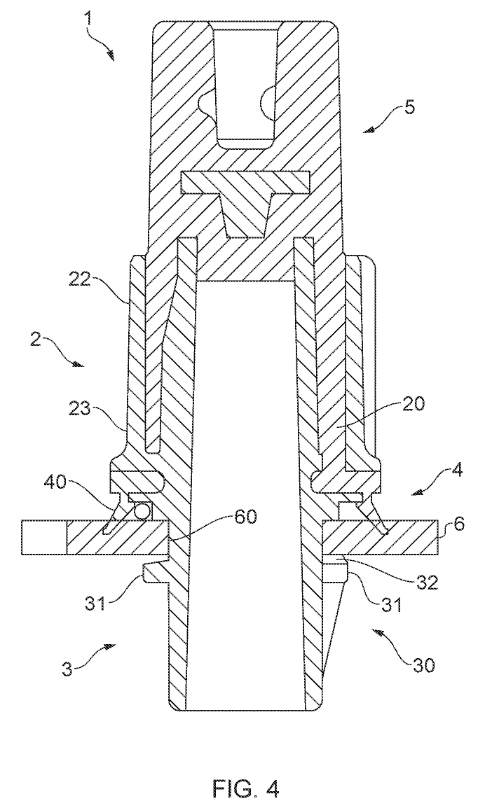

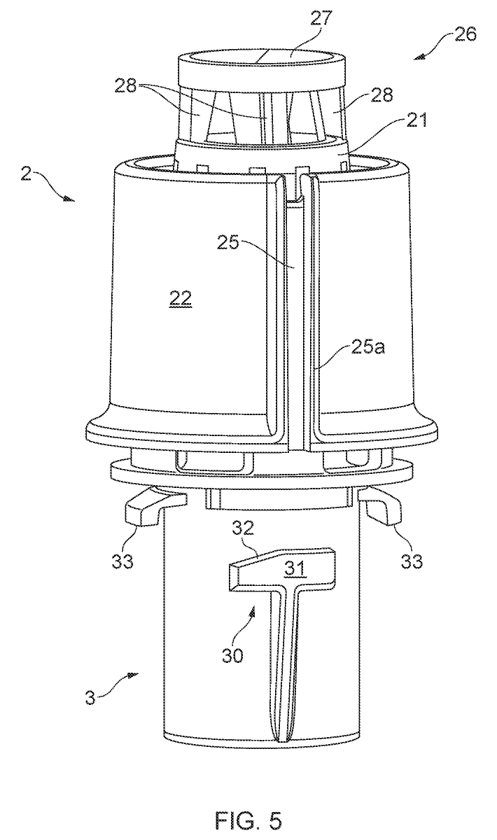

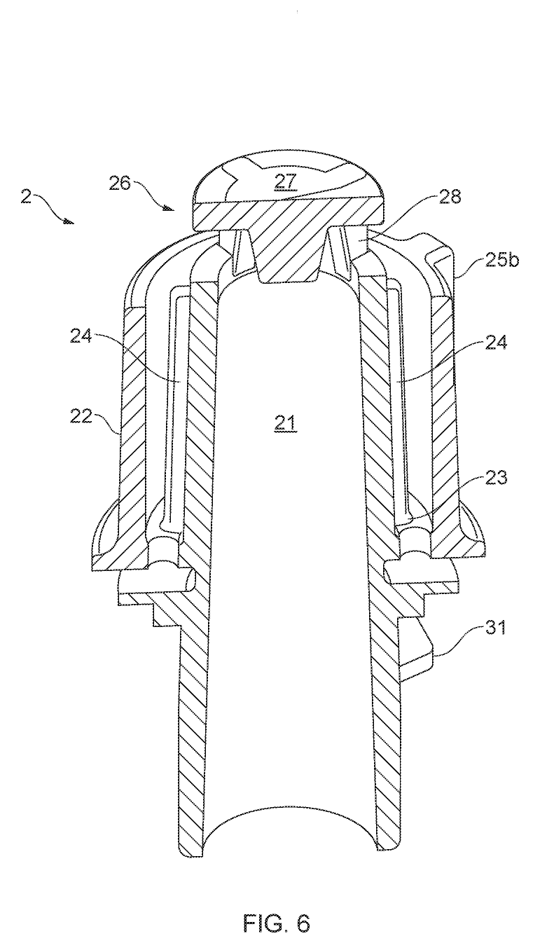

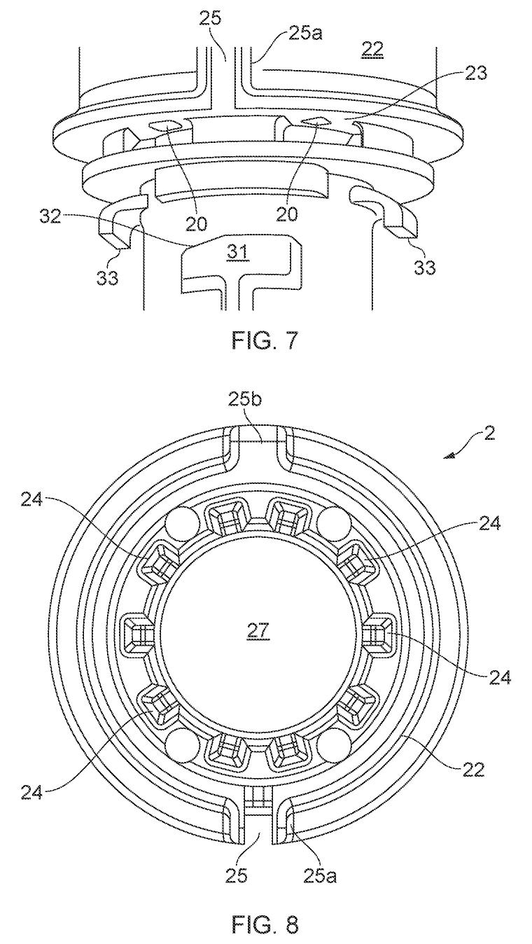

Referring now to FIGS. 1 to 4, a stop 1 can be seen for a vehicle hood or tailgate (only one panel 6 of which is shown in FIG. 4). The stop 1 comprises a base 2 with a connector 3 for mounting the stop 1 on the hood or tailgate of the vehicle, a gasket 4 for ensuring the seal against the hood or tailgate of the vehicle and a stopper 5 for engaging the vehicle body to dampen a closing force of the hood or tailgate.

The base 2 is made of a first material, while the stopper 5 and the gasket 4 are both made of a second material overmolded onto the first material. The second material is softer or more flexible than the first material. The first material can comprise a rigid thermoplastic. The second material can comprise an elastomer or resilient material such as a thermoplastic elastomer.

The base 2 comprises a central core 21 and a sleeve 22 enveloping the central core 21 and is connected to the central core 21 by an annular wall 23. The base 2 comprises several ridges 24 between the central core 21 and the sleeve 22. More specifically, the ridges 24 protrude radially from the central core 21 toward the sleeve 22.

Several holes 20 extend through the annular wall 23. A portion of the second material is held between the sleeve 22 and the central core 21 and extends through the annular wall 23 to connect the stopper 5 and the gasket 4. The ridges 24 are embedded in the second material, for example to keep the stopper 5 from rotating relative to the base 2.

The connector 3 is at a first end of stop 1, while the stopper 5 is at a second end. The gasket 4 is located between the annular wall 23 and the connector 3. There can be a space between the gasket 4 and the connector 3 so that a panel 6 of the hood or of the tailgate can be held between the connector 3 and the gasket 4, as shown in FIG. 4.

The sleeve 22 comprises a pair of ridges 25a, 25b on opposite sides of the sleeve 22. The ridges 25a, 25b provide means for engaging a tool to enable the tool to apply torque to install the stop 1 on a hood or tailgate.

A portion of the second material also extends along the outside of the sleeve 22. More specifically, the sleeve 22 comprises a channel 25 along its outer surface and the second material extends into the channel 25 to connect the stopper 5 and the gasket 4. The channel 25 is provided inside one ridge 25a of the pair of ridges 25a, 25b in this example.

The base 2 also comprises a cage 26 that is embedded in the second material to reinforce the connection between the base 2 and the stopper 5. The cage 26 comprises a substantially flat, disc-shaped support end 27, against which the stopper 5 is compressed. The support end 27 is connected to the rest of the base 2 by a plurality of legs 28 embedded in the second material.

The connector 3 comprises a bayonet connector 30 that fits into a hole 60 in the hood or tailgate panel 6, and the gasket 4 comprises a tapered skirt 40 that opens out towards the connector 3. The connector 3 also comprises a pair of reinforcement arms 33 extending from the central core 21 to the inside of the skirt 40.

When in use, the connector 3 is inserted into the hole 60 and rotated so that the parts 31 of the bayonet connector 30 engage in the panel 6. The bayonet connector 30 parts 31 comprise ramps 32 that force the panel 6 against the reinforcement arms 33, which flex to enable the panel 6 to sealingly engage with the tapered skirt 40.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

List of Reference Symbols

1 stop

2 base

20 hole

21 central core

22 sleeve

23 annular wall

24 ridges

25 channel

26 cage

27 support end

28 leg

3 connector

30 bayonet connector

31 bayonet connector parts

32 ramp

33 braces

4 gasket

40 tapered skirt

5 stopper

6 hood or tailgate panel

60 hole

What is claimed is:

1. A stop (1) for the hood or tailgate of a vehicle, the stop (1) comprising a base (2) with a connector (3) for mounting the stop (1) on the hood or tailgate of the vehicle, a gasket (4) to ensure the seal against the hood or tailgate of the vehicle and a stopper (5) for engaging the bodywork of the vehicle in order to dampen a closing force of the hood or tailgate, the base (2) being made of a first material and the stopper (5) and gasket (4) both being made of a second material overmolded onto the first material, the base (2) having one or more holes (20) through which the second material connects the stopper (5) and the gasket (4).

2. The stop (1) according to claim 1, wherein the base (2) comprises a central core (21) and a sleeve (22) enveloping the central core (21), a portion of the second material being held between the sleeve (22) and the central core (21).

3. The stop (1) according to claim 2, wherein the central core (21) is connected to the sleeve (22) by an annular wall (23) through which the hole or holes (20) extend.

4. The stop (1) according to claim 3, wherein the connector (3) is at a first end of the stop (1), the stopper (5) is at a second end of the stop (1) and the gasket (4) is located between the annular wall (23) and the connector (3).

5. The stop (1) according to claim 4, wherein there is a space between the gasket (4) and the connector (3) so that a panel (6) of the hood or of the tailgate can be held between the connector (3) and the gasket (4).

6. The stop (1) according to claim 5, wherein the base (2) comprises one or more ridges (24) between the central core (21) and the sleeve (22) that are embedded in the second material to keep the stopper (5) from rotating relative to the base (2).

7. The stop (1) according to claim 6, wherein the ridge or ridges (24) protrude radially from the central core (21) towards the sleeve (22).

8. The stop (1) according to claim 2, in which a portion of the second material extends along the outside of the sleeve (22).

9. The stop (1) according to claim 8, wherein the sleeve (22) comprises a channel (25) along its outer surface and the second material extends into the channel (25) to connect the stopper (5) and the gasket (4).

10. The stop (1) according to claim 9, wherein the channel (25) is provided inside one of two ridges (25a, 25b) on opposite sides of the sleeve (22).

11. The stop (1) according to claim 1, wherein the base (2) comprises a cage (26) that is embedded in the second material to reinforce the connection between the base (2) and the stopper (5).

12. The stop (1) according to claim 11, wherein the cage (26) comprises a support end (27) against which the stopper (5) is compressed when in use, the support end (27) being connected to the rest of the base (2) by a plurality of legs (28) embedded in the second material.

13. The stop (1) according to claim 12, wherein the support end (27) comprises a substantially flat disc.

14. The stop (1) according to claim 1, wherein the connector (3) comprises a bayonet connector (30) designed to fit into a hole (60) in a panel (6) of the hood or tailgate.

15. The stop (1) according to claim 1, wherein the gasket (4) comprises a tapered skirt (40) that opens out towards the connector (3).
